(19) United States
(12) Patent Application Publication
(10) Pub. No.: US 2024/0051059 A1
(43) Pub. Date: Feb. 15, 2024

(54) INSERT INTENDED FOR THE ASSEMBLY OF TWO PARTS AND ASSEMBLY METHOD USING THIS INSERT

(71) Applicant: GAMING ENGINEERING, COMMERCY (FR)

(72) Inventor: Alex GROJEAN, COMMERCY (FR)

(21) Appl. No.: 18/270,919

(22) PCT Filed: Jan. 4, 2022
(86) PCT No.: PCT/FR2022/050018

§ 371 Date: Jul. 5, 2023

(30) Foreign Application Priority Data
Jan. 5, 2021 (FR) FR21/00068

(51) Int. Cl. B23K 11/00

(52) U.S. Cl. CPC B23K 11/004

(57) ABSTRACT

The inserts includes ahead part including a docking portion intended to receive a welding electrode, a peripheral rim, intended to bear against the receiving part, and a body part intended to extend through the first part, the body part having a distal end intended to be welded to the second part. The docking portion is connected to the peripheral rim by connection means configured to allow the translation of the docking portion and of the body part with respect to the peripheral rim under the effect of a distal pressure exerted on the docking portion during the operation of assembling the first and second parts.

### CROSS REFERENCE TO RELATED APPLICATIONS

This application is a National Stage of PCT Application No. PCT/FR2022/050018 filed on Jan. 4, 2022, which claims priority to French Patent Application No. 21/00068 filed on Jan. 5, 2021, the contents each of which are incorporated herein by reference thereto.

### TECHNICAL FIELD

The present disclosure concerns an insert intended for the assembly of a part in a first material and of another part in a second material by electric resistance welding, and an assembly method using this insert.

### BACKGROUND

It is known to carry out assemblies of several parts by a spot welding technique.

The spot welding, or electric resistance welding, is an assembly solution which has the advantage of being economical and mechanically efficient, but which nevertheless remains limited to the assembly of two elements made of a material of the same type, for example two steel sheets.

Today, in the field of land or air transport, it is increasingly common to want to carry out assemblies of parts in different materials such as steel, aluminum, magnesium, composite materials.

These multi-material assemblies meet the problems of lightening the vehicles, reducing the energy consumption, improving the dynamic behavior, structural reinforcement to meet safety requirements, or even reducing the number of components involved in the manufacture of a vehicle.

To carry out these multi-material assemblies, it is known to use welding inserts like the one described in the patent document WO 2018/202999.

The patent document WO 2018/202999 describes a welding insert having thermal decoupling means. The thermal decoupling means make it possible to protect the first part from the heat released during the welding operation. It thus becomes possible to use a first part in a plastic or composite material.

It is sometimes necessary to tension the first part before the welding operation, for example to carry out a pre-plating of this first part or to carry out a cutout in order to implant the insert therein.

### BRIEF SUMMARY

Also, the disclosure aims to propose an insert making it possible to tension the part intended to receive this insert in order to carry out the assembly.

To this end, the subject of the disclosure is an insert intended for the assembly, by electric resistance welding, of a first part and of a second part, the insert comprising:
a head part comprising a docking portion, intended to receive a welding electrode,
a peripheral rim, intended to bear against the first part,
a body part intended to extend through the first part, the body part having a distal end intended to be welded to the second part,
characterized in that the docking portion is connected to the peripheral rim by connection means configured to allow the translation of the docking portion and of the body part with respect to the peripheral rim under the effect of a distal pressure exerted on the docking portion during the operation of assembling the first and second parts.

Thus, by releasing the docking portion, the connection means allow the body part to move up to the second part in order to initiate the welding operation. The insert according to the disclosure allows the peripheral rim to bear against the first part before the body part bears against the second part. This contact via the peripheral rim makes it possible to effectively tension the first part.

In the present application, by end or distal part of a component or of a device is meant the most distant part of a welding electrode applied on the insert. In the same way, by distal direction is meant the welding direction, from the insert towards the second part to be welded, and by proximal direction is meant the opposite direction, that is to say in the direction of the welding electrode applied against a docking face of the insert.

According to one embodiment, the connection means comprise a connection element forming an area of reduced thickness between the docking portion and the peripheral rim.

According to one embodiment, the connection element is a frangible connection element.

Preferably, the insert is one-piece.

According to one embodiment, the connection means delimit an opening, and the docking portion is press-fitted through this opening.

This makes it possible to thermally insulate the peripheral portion of the docking portion to further protect the receiving part from the heat released during the welding.

The docking portion may be a distinct part of the peripheral rim.

According to one embodiment, the connection means delimit an opening, and the insert comprises abutments to block or limit the translation of the docking portion through this opening.

The insert advantageously comprises thermal decoupling means interposed between the peripheral portion and the docking portion.

The docking portion may advantageously comprise an electrically conductive material while the peripheral rim comprises a dielectric material.

Advantageously, the docking portion and the body part extend orthogonally to the peripheral rim.

According to one embodiment, the insert comprises an axial abutment member configured to block the peripheral rim against the first part at the end of the assembly.

This characteristic makes it possible to increase the robustness of the assembly by preventing the separation of the docking portion and of the peripheral portion in axial tensile.

According to one embodiment, the insert comprises a proximal cavity intended to receive the axial abutment member at the end of the assembly.

According to one embodiment, the peripheral rim comprises a protuberance, and a distal end of the body part is configured to be arranged recessed from this protuberance or at the level of the latter in an initial state preceding the assembly.

According to one embodiment, the protuberance comprises a sharp distal edge.

According to another aspect, the disclosure also relates to a method for assembling a first part on a second part by means of an insert having all or part of the aforementioned characteristics, the assembly method comprising:
a step of bearing the insert against the first part, through the peripheral rim;
a step of positioning the body part against the second part, by moving the docking portion relative to the peripheral rim to drive this body part in the direction of the second part;
a step of welding the distal end of the body part to the second part.

The bearing may comprise a step of cutting out the first part at the time of the bearing of the peripheral rim against this first part.

The positioning step may comprise the prior separation of the docking portion and of the peripheral rim, and in particular the prior breaking of the frangible connection element.

The motion of the docking portion relative to the peripheral rim, and, if necessary, their prior separation, may be carried out by applying a distal force on the docking portion, preferably through a welding electrode.

Preferably, the method comprises a final step of immobilizing the peripheral rim against the first part through an axial abutment member. This step may comprise the formation of said axial abutment member at the end of the welding operation.

### BRIEF DESCRIPTION OF THE DRAWINGS

Other characteristics and advantages of the present disclosure will emerge clearly from the following detailed description of an embodiment, given by way of non-limiting example, with reference to the appended drawings in which:

FIG. 1 is a sectional view of an insert according to one embodiment of the disclosure, in an initial state preceding a welding operation,

FIG. 2 is a sectional view of an insert according to one embodiment of the disclosure, in an initial state preceding a welding operation,

FIG. 3 is a sectional view of an insert according to one embodiment of the disclosure, in an initial state preceding a welding operation,

FIG. 4 is a sectional view of an insert according to one embodiment of the disclosure, in an initial state preceding a welding operation,

FIG. 5 is a sectional view of an insert according to one embodiment of the disclosure, in an initial state preceding a welding operation,

FIG. 6 is a sectional view of an insert according to one embodiment of the disclosure, in a final state at the end of a welding operation.

### DETAILED DESCRIPTION

With reference to FIGS. 1 and 6, the disclosure concerns an insert 1 intended for the assembly of a first part 2 and of a second part 3, by electric resistance welding. The upper and lower parts may be in the form of two sheets arranged one against the other as shown in the figures. The first part 2 comprises a first material and the second part 3 comprises a second material that is electrically conductive and may be distinct from the first material. The first material may be a plastic or composite material. The second material may be metal, for example steel.

The insert 1 comprises a head part 4 having a docking portion 7 intended to receive a welding electrode and a peripheral rim 6 intended to hold the first part 2 pressed against the second part 3, connection means connecting the docking portion 7 and the peripheral rim 6, a central body part 5 intended to be welded to the second part 3, and, if necessary, thermal decoupling means configured to prevent a heat transmission between the body part 5 and the first part 2 at the time of the welding.

The body part 5 extends along a longitudinal axis A, on the underside of the head part 4. This body part 5 is intended to extend through a housing 20 of the first part 2 so that its distal end 50 may be welded to the second part 3.

The head part 4 comprises a peripheral rim 6 intended to bear against the first part 2. The peripheral rim 6 may be in the form of a disk or of a ring. It comprises a distal bearing surface 60 configured to bear against a proximal face of the first part 2. The distal bearing surface 60 may extend around the thermal decoupling means and may provide a 360° bearing. Advantageously, the axial distance between this distal bearing surface 60 and the welding end of the body part 5 is less than the distance separating the distal faces 21, 31 of the first and second parts 2, 3 before assembly.

The head part 4 also comprises a docking portion 7 advantageously forming a proximal projection with respect to the connection means. The docking portion 7 may extend to the center of the insert 1 and more particularly to the center of the peripheral rim 6, for example orthogonally thereto. It has a proximal end 70 delimiting a docking face 71 intended to receive a welding electrode. The docking face 71 may be the most proximal surface of the insert 1. The docking portion 7 extends along the central longitudinal axis A, orthogonal to the peripheral rim 6, and advantageously also projects with respect to the proximal face 61 of the peripheral rim 6. The docking portion 7 is advantageously integral with the body part 5 and may be produced with the latter in a single piece. Furthermore, the docking portion 7 and the body part 5 are preferably coaxial. They may have a similar diameter.

The head part 4 comprises connection means connecting the peripheral rim 6 and the docking portion 7. These connection means are configured to allow a translation along the longitudinal axis A of the docking portion 7 relative to the peripheral rim 6 when the insert 1 is used for the assembly of the upper and lower parts. The connection means may also be configured to hold the docking portion 7 and the peripheral rim 6 assembled together before the use of the insert 1.

According to the embodiments illustrated in FIGS. 1 to 4, these connection means are configured to hold the docking portion 7 fixed with respect to the peripheral rim 6 before the assembly of the upper and lower parts, and to release the docking portion 7 in order to allow its translation with respect to the peripheral rim 6 at the time of the assembly, once a pressure exceeding a predetermined threshold value is exerted on the docking face 71. The connection means are arranged between the central docking portion 7 and the peripheral rim 6, such that the docking portion 7 is cantilevered when the insert 1 is placed against the first part 2, which facilitates the separation of the docking portion 7 and of the peripheral rim 6 when the insert 1 is used for the assembly of the first and second parts 2, 3.

According to the embodiment illustrated on FIG. 5, the connection means are configured to allow a free movement of the docking portion 7 with respect to the peripheral rim 6 along the axis A before the use of the insert 1 for the assembly of the upper and lower parts. In this case, the insert 1 may have abutments to limit this movement and thus hold the docking portion 7 and the peripheral rim 6 together. The abutments may be arranged on either side of the connection means; they comprise for example a proximal abutment 13 which may correspond to the abutment member 9 described below, and a distal abutment 14 which may be in the form of a distal widening, in particular at the level of the distal end 50 of the body part 5.

As illustrated on FIGS. 1 to 5, the connection means comprise a connection element 8 connecting the docking portion 7 to the peripheral rim 6. This connection element 8 may be an area of reduced thickness relative to the peripheral rim 6. The connection element 8 may advantageously be in the form of a ring forming the junction between the peripheral rim 6 and the docking portion 7. This ring may be orthogonal to the axis A. The ring may have a thickness decreasing from the peripheral rim 6 in the direction of the docking portion 7.

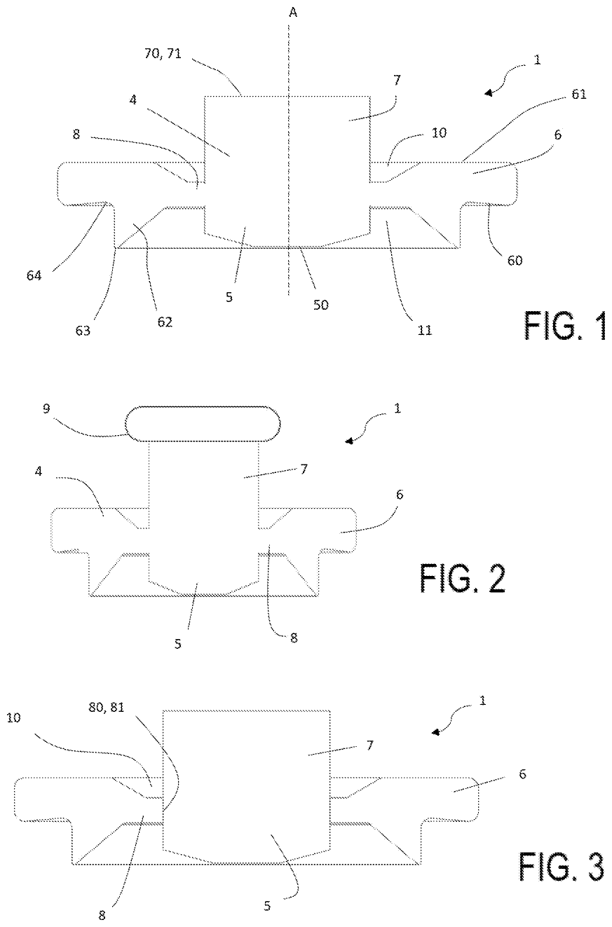

According to the embodiment of FIGS. 1 and 2, the insert 1 is in one-piece and the connection means comprise a frangible connection element 8. This frangible connection element 8 is intended to break under the effect of a distal pressure exerted on the docking face 71, thus releasing the docking portion 7 and the body part 5. This embodiment makes it possible to provide an insert 1 made from one and the same material, for example steel.

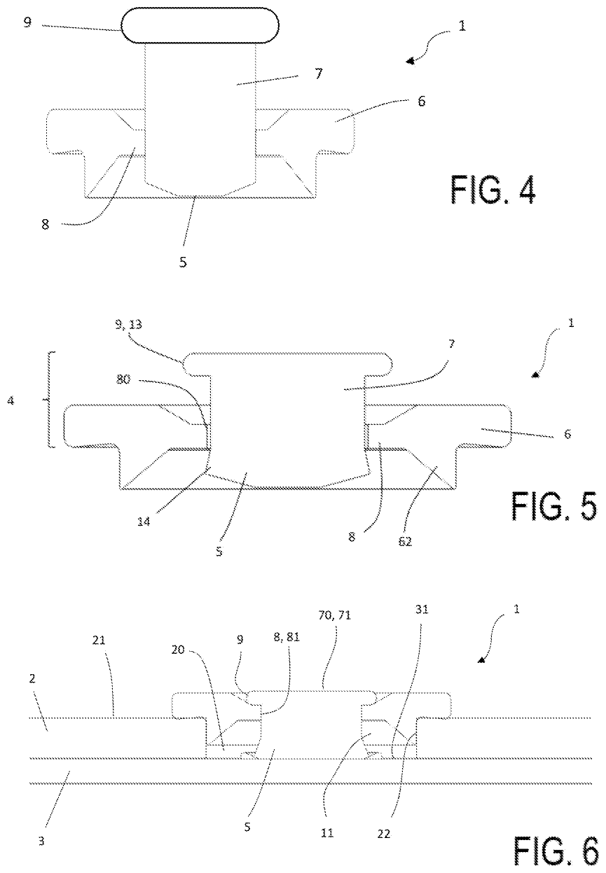

According to another embodiment illustrated on FIGS. 3 and 4, the docking portion 7 and the peripheral rim 6 are two distinct parts and the connection means, in particular the connection element 8, delimit a central opening 80 of a diameter smaller than that of the docking portion 7. Thus, the docking portion 7 is press-fitted in the connection element 8. The body part 5, the peripheral rim 6 and the docking portion 7 may be made of steel. Alternatively, it is possible to provide a docking portion 7 and a body part 5 in a first electrically conductive material, typically metallic such as steel, while the peripheral rim 6 is in a second dielectric material, for example polyetheretherketone (PEEK), which makes it possible to limit the heating of the peripheral rim 6 during the welding and consequently the heat transmitted to the first part 2.

According to the embodiment of FIG. 5, the docking portion 7 and the peripheral rim 6 are two distinct parts and the connection means, in particular the connection element 8, delimit a central opening 80 configured to allow a free translation of the docking portion 7 relative to the peripheral rim. This translation is however limited by the abutments 13, 14. The opening 80 has for example here a diameter equal to or greater than that of the docking portion 7. The body part 5, the peripheral rim 6 and the docking portion 7 may be made of steel. Alternatively, it is also possible to provide a docking portion 7 and a body part 5 in a first electrically conductive material, typically metallic such as steel, while the peripheral rim 6 is in a second dielectric material, for example polyetheretherketone (PEEK), which makes it possible to limit the heating of the peripheral rim 6 during the welding and consequently the heat transmitted to the first part 2.

When the insert 1 is used for the assembly of the first and second parts 2, 3, and, if necessary, after breaking the connection element 8 or releasing the docking portion 7, the connection means may be configured to delimit a tube 81 serving to guide the docking portion 7 in translation along the axis A.

The fact of benefiting from a docking portion 7 and a body part 5 which may move with respect to the peripheral rim 6 at the time of the assembly allows the peripheral rim 6 to bear against the first part 2 before the welding operation begins.

As can be seen on FIG. 2, 4 or 5, the insert 1 may include an abutment member 9, for example in the form of a radial rib. The abutment member 9 may be provided on the docking portion 7, for example at its proximal end 70. This abutment member 9 is intended to bear against the peripheral rim 6, and, if necessary, against the connection means, to block the translation of the docking portion 7 at the end of the welding. Thus, as seen on FIG. 6, in an assembled state, the peripheral rim 6 of the head part 4 is clamped between the abutment member 9 and the first part 2. If the insert 1 is initially devoid of abutment member 9, this may be formed during the assembly, as described in more detail below.

The connection means may extend in a recessed manner from the proximal face 61 of the peripheral rim 6. The insert 1 thus has an excavation or proximal cavity 10. The proximal cavity 10 of the insert 1 may be shaped to receive the abutment member 9. Preferably, at the end of the assembly, the abutment member 9 and the docking portion 7 are contained in this excavation and no longer project from the peripheral rim 6, as is visible on FIG. 6.

The insert 1 preferably comprises thermal decoupling means configured to limit the heating of the first part 2 at the time of the welding operation. The thermal decoupling means may be arranged around the body part 5. They have, for example, an annular area 11 extending all around the body part 5. This annular area 11 comprises an insulating material, for example air. For example, the annular area 11 may be a cavity formed around the body part 5. Here, the cavity is delimited by the protuberance 62, the body part 5 and the peripheral rim 6 or, if necessary, the temporary connection means. It will be noted that these thermal decoupling means may comprise all or part of the characteristics described in the patent document WO 2018/202999.

Alternatively or additionally, in the case of the insert 1 illustrated in FIGS. 3 to 5, the thermal decoupling means may be arranged between the docking portion 7 and the peripheral rim 6. For example, the thermal decoupling means comprise a surface treatment or a thermally insulating coating on a lateral surface of the docking portion 7 and possibly of the body part 5 to limit the transmission of heat to the peripheral rim 6, and in doing so to the first part 2.

As visible on the various figures, the peripheral rim 6 may comprise, projecting from its proximal face 61, a protuberance 62. This protuberance 62 extends, if necessary, around the thermal decoupling means. It is intended to be inserted through the first part 2 and bear against its wafer 22 in order to hold the body part 5 at a distance from the first part 2. The protuberance 62 may be in the form of a circumferential rib extending for example to 360°. According to one possibility, the distal edge 63 of this protuberance 62 may be sharp in order to cut out the first part 2, thus carrying out the housing 20 in which the insert 1 is positioned. If necessary, according to the example of FIGS. 1 to 4, the distal end 50 of the body part 5 is advantageously arranged at the level of a distal edge 63 of the protuberance 62 or proximally recessed with respect thereto before the use of the insert 1. Alternatively, the body part 5 may protrude with respect to this distal edge 63, the axial distance separating the distal end 50 of the body part 5 from the distal edge 63 of the protuberance 62 being equal to or less than the distance separating the distal faces 21, 31 of the upper and lower parts before assembly.

It should also be noted that the insert 1 may also comprise all or part of the characteristics of the insert 1 described in the patent document WO 2018/202999, in particular by way of non-limiting examples:
when the first part 2 is made of an electrically conductive material, the insert 1 may be at least partially covered with an electrically insulating coating to prevent a short circuit.
the body part 5 may have a decreasing section in the direction of its distal end 50.
a peripheral pocket 64 may be provided on the underside of the head part 4,
holding means configured to immobilize the insert 1 in position through the first part 2
one or more vent channels intended for the circulation of a cooling fluid on the docking face 71.

The disclosure also concerns an assembly method for assembling the first part 2 and the second part 3 by means of the insert 1 previously described.

The assembly method comprises a step (i) of bearing the insert 1 against the first part 2. This allows the first part 2 to be pressed or tensioned. During this step, only the peripheral rim 6 of the insert 1 exerts a pressure on the first and second parts 2, 3, through the distal bearing face or the protuberance 62 of the peripheral rim 6. The body part 5 is at a distance of the second part 3, as is the case for the insert 1 according to FIGS. 1 to 4, or is possibly in contact with the second part 3 for example under gravity, as is the case for the insert 1 of FIG. 5, but without exerting a pressure (since the docking portion 7 and the body part 5 are free with respect to the peripheral rim 6). The connection means may be cantilevered.

The method may comprise a step of cutting out the first part 2 in order to create this housing. This cutting step may be carried out through the sharp distal edge of the protuberance.

The method comprises a step (ii) of moving the body part 5 to approach it or bring it into contact with the second part 3. This step comprises the exertion of a distal pressure, preferably exerted by the electrode welding, on the docking portion 7 so that the distal end 50 of the body part 5 is pressed against the second part 3. This pressure may involve the separation of the peripheral rim 6 and of the docking portion 7. The docking portion 7 then translates with respect to the peripheral rim 6, carrying with it the body part 5 which it pushes to the second part 3.

Once the contact has been established between the body part 5 and the second part 3, the method comprises a step (iii) of welding itself where the welding energy, transmitted to the docking portion 7 and to the body part 5 through the electrodes, triggers the fusion at the distal end of the body part 5. The body part 5 is consumed and the docking portion 7, under the pressure of the electrodes, continues to move in the direction of the second part 3 to hold the contact.

The method may include a blocking step (iv) comprising the abutment of the axial abutment member 9 against the peripheral rim 6 as shown on FIG. 6. If the docking portion 7 is initially devoid of abutment member 9, the method may comprise a step of forming a bead of material at the distal end of the docking portion 7. In this case, once the welding core performed at the distal end of the body part 5, the contact area representing the greatest resistivity materializes between the top of the docking portion 7 and the welding electrode. The temperature then rises in the top of the docking portion 7. Faced with the rise in temperature, the material creeps under the closing pressure exerted by the welding electrodes. This flow makes it possible to create the bead of material at the top of the docking portion 7, thus forming the abutment member 9 and finalizing the assembly sequence.

Of course, the disclosure is in no way limited to the embodiment described above, this embodiment having been given only by way of example. Modifications are possible, in particular from the point of view of the constitution of the various devices or by the substitution of technical equivalents, without thereby departing from the scope of protection of the disclosure. Thus, the abutment 13 may for example be arranged, not at the proximal end 70, but on an intermediate portion of the docking portion 7.

1. An insert intended for the assembly, by electric resistance welding, of a first part and of a second part, the insert comprising:
a head part comprising a docking portion, intended to receive a welding electrode,
a peripheral rim, intended to bear against the first part,
a body part intended to extend through the first part, the body part having a distal end intended to be welded to the second part,
wherein the docking portion is connected to the peripheral rim by connection means configured to allow translation of the docking portion and of the body part with respect to the peripheral rim under the effect of a distal pressure exerted on the docking portion during the operation of assembling the first part and the second part.

2. The insert according to claim 1, wherein the connection means comprise a connection element forming an area of reduced thickness between the docking portion and the peripheral rim.

3. The insert according to claim 2, wherein the connection element is a frangible connection element.

4. The insert according to claim 1, wherein the connection means delimit an opening, and the docking portion is press-fitted through this opening.

5. The insert according to claim 1, wherein the connection means delimit an opening, and the insert comprises abutments for blocking or limiting translation of the docking portion through this opening.

6. The insert according to claim 1, wherein the insert comprises an axial abutment member configured to block the peripheral rim against the first part at the end of the assembly of the first part and the second part.

7. The insert according to claim 6, wherein the insert comprises a proximal cavity intended to receive the axial abutment member at the end of the assembly of the first part and the second part.

8. The insert according to claim 1, wherein the peripheral rim comprises a protuberance, and a distal end of the body part is configured to be arranged recessed from this protuberance or at a level of the protuberance in an initial state preceding the assembly of the first part and the second part.

9. The insert according to claim 8, wherein the protuberance comprises a sharp distal edge.

10. A method for assembling a first part on a second part by means of an insert according to claim 1, the assembly-method comprising:
a step of bearing the insert against the first part, through the peripheral rim;
a step of positioning the body part against the second part, by moving the docking portion relative to the peripheral rim to drive this body part in a direction of the second part;
a step of welding the distal end of the body part to the second part.

11. The insert according to claim 2, wherein the connection means delimit an opening, and the docking portion is press-fitted through this opening.

12. The insert according to claim 2, wherein the connection means delimit an opening, and the insert comprises abutments for blocking or limiting translation of the docking portion through this opening.

13. The insert according to claim 2, wherein the insert comprises an axial abutment member configured to block the peripheral rim against the first part at the end of the assembly of the first part and the second part.

14. The insert according to claim 3, wherein the insert comprises an axial abutment member configured to block the peripheral rim against the first part at the end of the assembly of the first part and the second part.

15. The insert according to claim 4, wherein the insert comprises an axial abutment member configured to block the peripheral rim against the first part at the end of the assembly of the first part and the second part.

16. The insert according to claim 5, wherein the insert comprises an axial abutment member configured to block the peripheral rim against the first part at the end of the assembly of the first part and the second part.

17. The insert according to claim 11, wherein the insert comprises an axial abutment member configured to block the peripheral rim against the first part at the end of the assembly of the first part and the second part.

18. The insert according to claim 12, wherein the insert comprises an axial abutment member configured to block the peripheral rim against the first part at the end of the assembly of the first part and the second part.

19. The insert according to claim 17, wherein the insert comprises a proximal cavity intended to receive the axial abutment member at the end of the assembly of the first part and the second part.

20. The insert according to claim 18, wherein the insert comprises a proximal cavity intended to receive the axial abutment member at the end of the assembly of the first part and the second part.
